(19) United States
(12) Patent Application Publication
(10) Pub. No.: US 2025/0039193 A1
(43) Pub. Date: Jan. 30, 2025

(54) INTRUSION PREVENTION BASED ON INFECTION CHAINS

(71) Applicant: Palo Alto Networks, Inc., Santa Clara, CA (US)

(72) Inventors: Yanhui Jia, San Jose, CA (US); Taojie Wang, San Jose, CA (US); Christian Elihu Navarrete Discua, San Jose, CA (US); Shengming Xu, San Jose, CA (US)

(21) Appl. No.: 18/227,601

(22) Filed: Jul. 28, 2023

(51) Int. Cl. H04L 9/40

(52) U.S. Cl. CPC H04L 63/1416; H04L 63/1425; H04L 63/145

(57) ABSTRACT

Techniques for intrusion prevention based on infection chains are disclosed. In some embodiments, a system, a process, and/or a computer program product for intrusion prevention based on infection chains includes monitoring network traffic at a security platform; prefiltering the monitored network traffic at the security platform to select a subset of the network traffic to perform further analysis using a plurality of signatures based on infection chains; and determining whether a plurality of sessions in the network traffic is associated with advanced persistent threat (APT) attack traffic activity based on a match with at least one of the plurality of signatures based on the infection chains.

### BACKGROUND OF THE INVENTION

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

### BRIEF DESCRIPTION OF THE DRAWINGS

Various embodiments of the invention are disclosed in the following detailed description and the accompanying drawings.

FIG. 1 illustrates an example of an environment in which malicious applications (“malware”) are detected and prevented from causing harm.

FIG. 2A illustrates an embodiment of a data appliance.

FIG. 2B is a functional diagram of logical components of an embodiment of a data appliance.

FIG. 3 illustrates an example of logical components that can be included in a system for analyzing samples.

FIG. 4 is a component diagram of the advanced persistent threat (APT) detector in accordance with some embodiments.

FIG. 5A illustrates elements of multi-session infection chain based APT detection signatures in accordance with some embodiments.

FIG. 5B is an annotated portion of a packet capture (pcap) log that illustrates an example APT attack activity pattern that can be used for generating multi-session infection chain based APT detection signatures in accordance with some embodiments.

FIG. 6 is a flow diagram of a process for intrusion prevention based on infection chains in accordance with some embodiments.

FIG. 7 is a flow diagram of a process for intrusion prevention based on infection chains in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as one or more software applications on various types of devices, such as computer servers, gateways, network/routing devices (e.g., network routers), and data appliances (e.g., security appliances or other types of special purpose devices), and in various implementations, certain operations can be implemented in special purpose hardware, such as an ASIC or FPGA.

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QOS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content—not just ports, IP addresses, and packets—using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)) as well as CN Series container next generation firewalls. For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

### Overview of Techniques for Intrusion Prevention Based on Infection Chains

Generally, existing anti-malware security solutions often fail to detect new malware or new malware variants based on malware signatures (e.g., predefined patterns, such as Intrusion Prevention System (IPS) signatures). Specifically, existing anti-malware security solutions generally fail to effectively detect advanced persistent threat (APT) attacks using pattern matching/signatures (e.g., currently, signature-based content IPS solutions generally cannot detect APT attacks, which often span a plurality of sessions). These shortcomings associated with existing malware solutions expose enterprises to significant security risks due to the failure to detect such APT attacks.

Thus, what are needed are anti-malware security solutions that can efficiently and effectively detect advanced persistent threat (APT) attacks.

Accordingly, new and improved techniques for intrusion prevention based on infection chains are disclosed.

In some embodiments, a system, a process, and/or a computer program product for intrusion prevention based on infection chains includes monitoring network traffic at a security platform (e.g., a firewall); prefiltering the monitored network traffic at the security platform to select a subset of the network traffic to perform further analysis using a plurality of signatures based on infection chains; and determining whether the plurality of sessions in the network traffic is associated with advanced persistent threat (APT) attack traffic activity based on a match with at least one of the plurality of signatures based on infection chains.

For example, various new malware detection techniques are disclosed that include a system, a process, and/or a computer program product for infection chain based threat detection that can prevent, for example, an APT attack based on matching infection chain content (e.g., monitored/extracted content associated with an APT related attack chain, which can include a plurality of actions/behaviors and/or a specific sequence of actions/behaviors performed typically across distinct sessions). Examples of captured APT related malicious traffic including packet captures (pcaps) are publicly available for known, previously identified APT attacks (see, e.g., malware traffic analysis information on various APT related attacks that is publicly available at https://malware-traffic-analysis.net/2023/index.html, such as for an entry/row on that web page that is dated 2023 Feb. 3 for DEV-0569, which includes an APT attack/infection chain that starts with a user downloading a compromised/malicious Google advertisement that initiates a “FakeBat” Loader of a program/executable that then executes a Redline Stealer and Gozi/ISFB that performs data exfiltration from a targeted user's/enterprise's device).

As such, these observed plurality of actions/behaviors and/or a specific sequence of actions/behaviors performed typically across distinct sessions can be monitored by a security platform/solution (e.g., a firewall or other security entity that can monitor network traffic for an enterprise) to trigger detection using the disclosed techniques for intrusion prevention based on infection chains as will be further described below with respect to various embodiments.

In an example implementation, a new infection chain based threat detection system can include an infection chain content update component, an infection chain content generation component, and an infection chain content engine. More specifically, the infection chain content generation component can translate and transform the infection chain threat intelligence into a new, automatically generated infection chain behavior signature. The infection chain content engine can load infection chain behavior signature content (e.g., a plurality of infection chain behavior signatures) and then report any detected APT attacks for a policy decision based on a match with one or more infection chain behavior signatures. Also, the infection chain content update component can update the infection chain behavior signature content in near real-time, such as will be further described below with respect to various embodiments.

In some embodiments, a system, a process, and/or a computer program product for intrusion prevention based on infection chains further includes parsing threat intelligence information to extract a set of behaviors associated with an advanced persistent threat (APT) attack; extracting the set of behaviors associated with an APT attack; and automatically generating a multi-session-based detection signature with prefilter and logic based on the infection chain.

As such, the disclosed techniques for intrusion prevention based on infection chains can facilitate detection of APT attacks (e.g., new or zero day APT attacks) based on matching a plurality/sequence of behaviors that are determined to be associated with an APT attack (e.g., a potential/likely APT attack), which could not previously be detected by existing, single session IPS signature-based detection approaches (e.g., applied by firewalls and/or other security entities/solutions).

Moreover, the APT attack detection results can then be shared with other inline and/or offline detection/prevention security solutions to protect that and/or other enterprise customers.

Accordingly, new and improved security solutions that facilitate intrusion prevention based on infection chains using a security platform (e.g., a firewall (FW)/Next Generation Firewall (NGFW), a network sensor acting on behalf of the firewall, or another (virtual and/or container implemented) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) are disclosed in accordance with some embodiments.

These and other embodiments and examples for intrusion prevention based on infection chains will be further described below.

### Example System Architectures for Intrusion Prevention Based on Infection Chains

Accordingly, in some embodiments, the disclosed techniques include providing a security platform (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, such as PANOS executing on a virtual/physical NGFW solution commercially available from Palo Alto Networks, Inc. or another security platform/NFGW, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) configured to provide DPI capabilities (e.g., including stateful inspection) for, for example, applying the disclosed techniques for intrusion prevention based on infection chains, as will now be further described below.

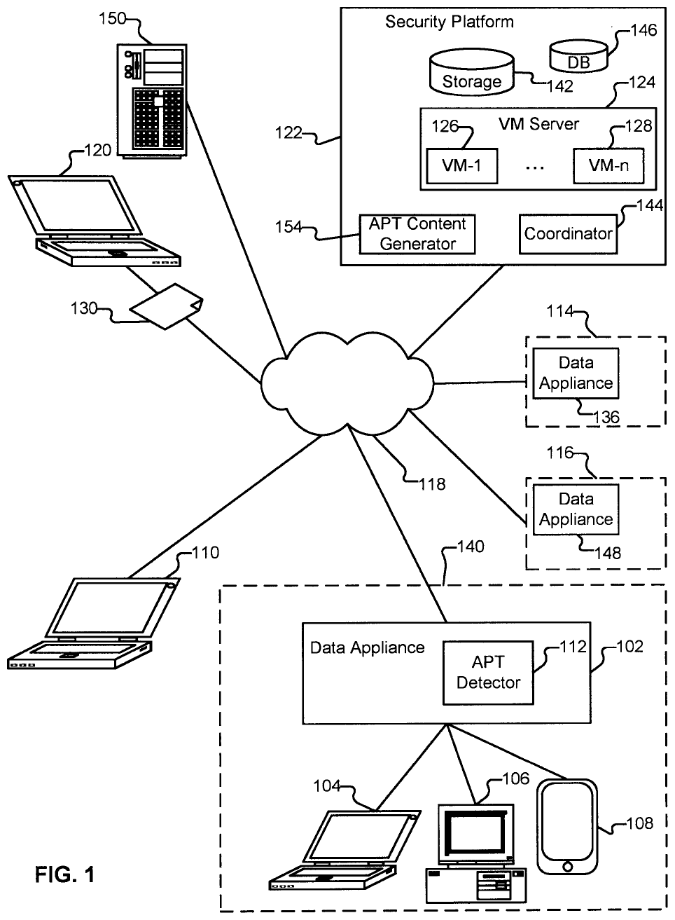

FIG. 1 illustrates an example of an environment in which malicious applications (“malware”) are detected and prevented from causing harm. As will be described in more detail below, malware classifications (e.g., as made by security platform 122) can be variously shared and/or refined among various entities included in the environment shown in FIG. 1. And, using techniques described herein, devices, such as endpoint client devices 104-110 as well as various other devices/entities within a secured enterprise network 140, can be protected from such malware (e.g., including previously unknown/new variants of malware, such as various zero-day/variant APT attacks, such as further described below).

“Malware” as used herein refers to an application that engages in behaviors, whether clandestinely or not (and whether illegal or not), of which a user does not approve/would not approve if fully informed. Examples of malware that can be included in various APT attacks include ransomware, Trojans, viruses, rootkits, spyware, hacking tools, etc. One example of malware is a desktop/mobile application that encrypts a user's stored data (e.g., ransomware). Another example of malware is C2 malware that can be included in various APT attacks, such as similarly described above and further described below. Other forms of malware (e.g., keyloggers) that can be included in various APT attacks can also be detected/thwarted using the disclosed techniques for intrusion prevention based on infection chains as will be further described herein.

Techniques described herein can be used in conjunction with a variety of platforms (e.g., servers, computing appliances, virtual/container environments, desktops, mobile devices, gaming platforms, embedded systems, etc.) and/or for automated detection of a variety of forms of malware (e.g., new and/or variants of malware, such as various new/zero-day or evolving/variant APT attacks, etc.). In the example environment shown in FIG. 1, client devices 104-108 are a laptop computer, a desktop computer, and a tablet (respectively) present in enterprise network 140. Client device 110 is a laptop computer present outside of enterprise network 140.

Data appliance 102 (e.g., a security platform, which can include a firewall that can be implemented in hardware, software, and/or a combination thereof, such as similarly described above) is configured to enforce policies regarding communications between client devices, such as client devices 104 and 106, and nodes outside of enterprise network 140 (e.g., reachable via external network 118, including the Internet). Examples of such policies include ones governing traffic shaping, quality of service, and routing of traffic. Other examples of policies include security policies such as ones requiring the scanning for threats in incoming (and/or outgoing) email attachments, website content, files exchanged through instant messaging programs, and/or other file transfers. In some embodiments, data appliance 102 is also configured to enforce policies with respect to traffic that stays within enterprise network 140. Specifically, in this example implementation, data appliance 102 includes an APT detector 112 for performing the disclosed techniques for intrusion prevention based on infection chains as will be further described herein.

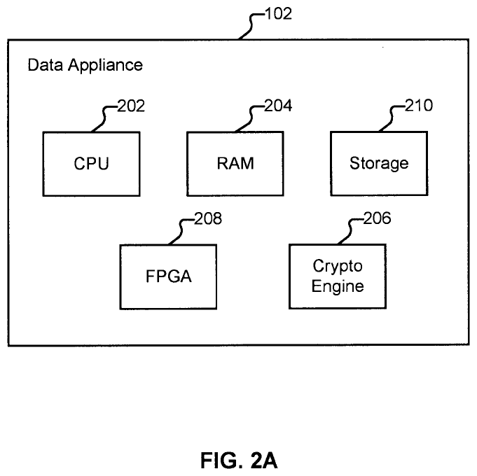

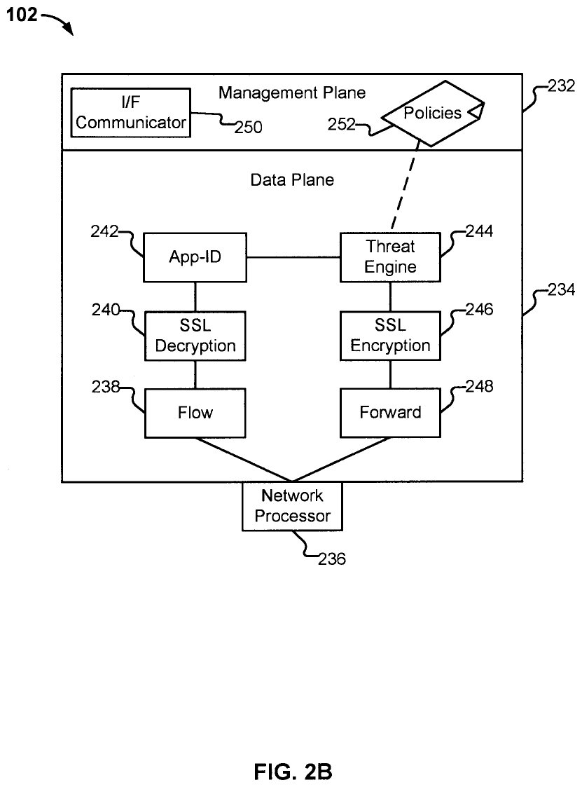

An embodiment of a data appliance is shown in FIG. 2A. The example shown is a representation of physical components that are included in data appliance 102, in various embodiments. Specifically, data appliance 102 includes a high performance multi-core Central Processing Unit (CPU) 202 and Random Access Memory (RAM) 204. Data appliance 102 also includes a storage 210 (such as one or more hard disks or solid state storage units). In various embodiments, data appliance 102 stores (whether in RAM 204, storage 210, and/or other appropriate locations) information used in monitoring enterprise network 140 and implementing disclosed techniques. Examples of such information include application identifiers, content identifiers, user identifiers, requested URLs, IP address mappings, policy and other configuration information, signatures (e.g., including signatures based on infection chains as further described herein), hostname/URL categorization information, malware profiles, and machine learning (ML) models. Data appliance 102 can also include one or more optional hardware accelerators. For example, data appliance 102 can include a cryptographic engine 206 configured to perform encryption and decryption operations, and one or more Field Programmable Gate Arrays (FPGAs) 208 configured to perform matching, act as network processors, and/or perform other tasks.

Functionality described herein as being performed by data appliance 102 can be provided/implemented in a variety of ways. For example, data appliance 102 can be a dedicated device or set of devices. The functionality provided by data appliance 102 can also be integrated into or executed as software on a general purpose computer, a computer server, a gateway, and/or a network/routing device. In some embodiments, at least some services described as being provided by data appliance 102 are instead (or in addition) provided to a client device (e.g., client device 104 or client device 110) by software executing on the client device.

Whenever data appliance 102 is described as performing a task, a single component, a subset of components, or all components of data appliance 102 may cooperate to perform the task. Similarly, whenever a component of data appliance 102 is described as performing a task, a subcomponent may perform the task and/or the component may perform the task in conjunction with other components. In various embodiments, portions of data appliance 102 are provided by one or more third parties. Depending on factors such as the amount of computing resources available to data appliance 102, various logical components and/or features of data appliance 102 may be omitted and the techniques described herein adapted accordingly. Similarly, additional logical components/features can be included in embodiments of data appliance 102 as applicable. One example of a component included in data appliance 102 in various embodiments is an application identification engine which is configured to identify an application (e.g., using various application signatures for identifying applications based on packet flow analysis). For example, the application identification engine can determine what type of traffic a session involves, such as Web Browsing-Social Networking; Web Browsing-News; SSH; and so on.

FIG. 2B is a functional diagram of logical components of an embodiment of a data appliance. The example shown is a representation of logical components that can be included in data appliance 102 in various embodiments. Unless otherwise specified, various logical components of data appliance 102 are generally implementable in a variety of ways, including as a set of one or more scripts (e.g., written in Go, Java, Python, etc., as applicable).

As shown, data appliance 102 comprises a firewall, and includes a management plane 232 and a data plane 234. The management plane is responsible for managing user interactions, such as by providing a user interface for configuring policies and viewing log data. The data plane is responsible for managing data, such as by performing packet processing and session handling.

Network processor 236 is configured to receive packets from client devices, such as client device 108, and provide them to data plane 234 for processing. Whenever flow module 238 identifies packets as being part of a new session, it creates a new session flow. Subsequent packets will be identified as belonging to the session based on a flow lookup. If applicable, SSL decryption is applied by SSL decryption engine 240. Otherwise, processing by SSL decryption engine 240 is omitted. Decryption engine 240 can help data appliance 102 inspect and control SSL/TLS and SSH encrypted traffic, and thus help to stop threats that might otherwise remain hidden in encrypted traffic. Decryption engine 240 can also help prevent sensitive content from leaving enterprise network 140. Decryption can be controlled (e.g., enabled or disabled) selectively based on parameters such as: URL category, traffic source, traffic destination, user, user group, and port. In addition to decryption policies (e.g., that specify which sessions to decrypt), decryption profiles can be assigned to control various options for sessions controlled by the policy. For example, the use of specific cipher suites and encryption protocol versions can be required.

Application identification (APP-ID) engine 242 is configured to determine what type of traffic a session involves. As one example, application identification engine 242 can recognize a GET request in received data and conclude that the session requires an HTTP decoder. In some cases, such as a web browsing session, the identified application can change, and such changes will be noted by data appliance 102. For example, a user may initially browse to a corporate Wiki (classified based on the URL visited as “Web Browsing-Productivity”) and then subsequently browse to a social networking site (classified based on the URL visited as “Web Browsing-Social Networking”). Distinct types of protocols have corresponding decoders.

Based on the determination made by application identification engine 242, the packets are sent, by threat engine 244, to an appropriate decoder configured to assemble packets (which may be received out of order) into the correct order, perform tokenization, and extract out information. Threat engine 244 also performs signature matching to determine what should happen to the packet. As needed, SSL encryption engine 246 can re-encrypt decrypted data. Packets are forwarded using a forward module 248 for transmission (e.g., to a destination).

As also shown in FIG. 2B, policies 252 are received and stored in management plane 232. Policies can include one or more rules, which can be specified using domain and/or host/server names, and rules can apply one or more signatures or other matching criteria or heuristics, such as for security policy enforcement for intrusion prevention based on infection chains from monitored session traffic flows as further described herein. Example policies can include intrusion prevention policies using the disclosed techniques for intrusion prevention based on infection chains. An interface (I/F) communicator 250 is provided for management communications (e.g., via (REST) APIs, messages, or network protocol communications or other communication mechanisms).

### Security Platform

Returning to FIG. 1, suppose a malicious individual (using system 120) has created malware 130, such as a new/variant of malware associated with an APT attack (e.g., a zero-day/variant APT attack). As discussed above, APT attack traffic can generally avoid detection by preexisting, single session IPS signatures (e.g., the malware can be delivered to endpoint devices of users via a compromised web site when the user visits/browses to the compromised web site, such as a compromised/malicious web server for a malware advertisement, or via a phishing attack, etc.). The malicious individual/attacker hopes that a client device, such as client device 104, will execute a copy of malware 130 to unpack the malware executable/payload, compromising the client device, and, e.g., causing the client device to become a bot in a botnet or to perform other undesired/malicious activities, such as for data exfiltration. The compromised client device can then be instructed to perform tasks (e.g., cryptocurrency mining, data exfiltration from the device/enterprise network, or participating in denial of service attacks, etc.) and to report information to an external entity, such as command and control (C2/C&C) server 150, as well as to receive instructions from C2 server 150, as applicable.

Suppose data appliance 102 has intercepted an email sent (e.g., by system 120) to a user, “Alice,” who operates client device 104. In this example, Alice receives the email and clicks on the link to a phishing/compromised site that could result in an attempted download of malware 130 by Alice's client device 104. However, in this example, data appliance 102 can perform the disclosed techniques for intrusion prevention based on infection chains and block access from Alice's client device 104 to the packed malware content and to thereby preempt and prevent any such download of malware 130 to Alice's client device 104. As will be further described below, data appliance 102 performs the disclosed techniques for sample traffic based self-learning malware detection, such as further described below, to detect and block such malware 130 from harming Alice's client device 104.

In various embodiments, data appliance 102 is configured to work in cooperation with security platform 122. As one example, security platform 122 can provide to data appliance 102 a set of signatures of known-malicious files including the new infection chain based signatures as further described herein (e.g., as part of a subscription). If a signature for malware 130 is included in the set (e.g., an MD5 hash of malware 130), data appliance 102 can prevent the transmission of malware 130 to client device 104 accordingly (e.g., by detecting that an MD5 hash of the email attachment sent to client device 104 matches the MD5 hash of malware 130). Security platform 122 can also provide to data appliance 102 a list of known malicious domains and/or IP addresses, allowing data appliance 102 to block traffic between enterprise network 140 and C2 server 150 (e.g., where C&C server 150 is known to be malicious). The list of malicious domains (and/or IP addresses) can also help data appliance 102 determine when one of its nodes has been compromised. For example, if client device 104 attempts to contact C2 server 150, such attempt is a strong indicator that client 104 has been compromised by malware (and remedial actions should be taken accordingly, such as quarantining client device 104 from communicating with other nodes within enterprise network 140).

As will be described in more detail below, security platform 122 can also receive a copy of malware 130 from data appliance 102 to perform cloud-based security analysis for performing (e.g., in whole or in part) the disclosed techniques of intrusion prevention based on infection chains, and the malware verdict (e.g., which may be an APT attack verdict if there is a match with an infection chain based signature as further described herein) can be sent back to data appliance 102 for enforcing the security policy to thereby safeguard Alice's client device 104 from execution of malware 130 (e.g., to block malware 130 from access on client device 104).

Further, security platform 122 can also provide other types of information to data appliance 102 (e.g., as part of a subscription) such as a set of information for performing the disclosed techniques for intrusion prevention based on infection chains usable by data appliance 102 to perform inline analysis of such malware files as will be further described below.

A variety of actions can be taken by data appliance 102 if no signature for an attachment is found, in various embodiments. As a first example, data appliance 102 can fail-safe, by blocking transmission of any attachments not whitelisted as benign (e.g., not matching signatures of known good files). A drawback of this approach is that there may be many legitimate attachments unnecessarily blocked as potential malware when they are in fact benign. As a second example, data appliance 102 (e.g., a security platform) can fail-danger, by allowing transmission of any attachments not blacklisted as malicious (e.g., not matching signatures of known bad files). A drawback of this approach is that newly created malware (previously unseen by platform 122) will not be prevented from causing harm. As a third example, data appliance 102 can be configured to provide the file (e.g., malware 130) to security platform 122 for static/dynamic analysis, to determine whether it is malicious and/or to otherwise classify it.

Security platform 122 stores copies of received samples in storage 142 and analysis is commenced (or scheduled, as applicable). One example of storage 142 is an Apache Hadoop Cluster (HDFS). Results of analysis (and additional information pertaining to the applications) are stored in database 146. In the event an application is determined to be malicious, data appliances can be configured to automatically block the file download based on the analysis result. Further, a signature can be generated for the malware and distributed (e.g., to data appliances such as data appliances 102, 136 located in the cloud and/or another enterprise data computing location as shown at 114, and 148 located in the cloud and/or another enterprise data computing location as shown at 116) to automatically block future file transfer requests to download the file determined to be malicious.

In various embodiments, security platform 122 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 122 can be implemented across a scalable infrastructure comprising multiple such servers, solid state drives, and/or other applicable high-performance hardware. Security platform 122 can comprise several distributed components, including components provided by one or more third parties. For example, portions or all of security platform 122 can be implemented using the Amazon Elastic Compute Cloud (EC2) and/or Amazon Simple Storage Service (S3). Further, as with data appliance 102, whenever security platform 122 is referred to as performing a task, such as storing data or processing data, it is to be understood that a sub-component or multiple sub-components of security platform 122 (whether individually or in cooperation with third party components) may cooperate to perform that task. As one example, security platform 122 can optionally perform static/dynamic analysis in cooperation with one or more virtual machine (VM) servers, such as VM server 124.

An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 122, but may also be provided by a third party. As one example, the virtual machine server can rely on EC2, with the remainder portions of security platform 122 provided by dedicated hardware owned by and under the control of the operator of security platform 122. VM server 124 is configured to provide one or more virtual machines 126-128 for emulating client devices. The virtual machines can execute a variety of operating systems and/or versions thereof. Observed behaviors resulting from executing applications in the virtual machines are logged and analyzed (e.g., for indications that the application is malicious). In some embodiments, log analysis is performed by the VM server (e.g., VM server 124). In other embodiments, analysis is performed at least in part by other components of security platform 122, such as a coordinator 144.

In various embodiments, security platform 122 makes available results of its analysis of samples via a list of signatures (e.g., and/or other identifiers) to data appliance 102 as part of a subscription. For example, security platform 122 can periodically send a content package that identifies malware files/traffic/content, including for infection chain based IPS detection of various APT attacks, etc. (e.g., daily, hourly, or some other interval, and/or based on an event configured by one or more policies). An example content package that includes infection chain based signatures for IPS detection of APT attacks is generated using an APT content generator 154 that can periodically generate new infection chain based signatures for IPS detection of APT attacks that are provided to APT detector 112 to facilitate automated detection of new/variant APT attacks to protect enterprise network 140, such as further described below. The subscription can cover the analysis of just those files intercepted by data appliance 102 and sent to security platform 122 by data appliance 102, and can also cover signatures of malware known to security platform 122. As will be described in more detail below, platform 122 can also utilize other types of information/heuristics for performing network traffic-based heuristic IPS malware detection using the disclosed techniques for infection chain based signatures for IPS detection of APT attacks. Specifically, platform 122 can utilize APT content generator 154, which can help data appliance 102 detect and perform inline blocking of potentially new/variant APT attacks (e.g., zero-day APT attacks) using infection chains generated by the APT content generator as further described below with respect to various embodiments.

In various embodiments, security platform 122 is configured to provide security services to a variety of entities in addition to (or, as applicable, instead of) an operator of data appliance 102. For example, other enterprises, having their own respective enterprise networks 114 and 116, and their own respective data appliances 136 and 148, can contract with the operator of security platform 122. Other types of entities can also make use of the services of security platform 122. For example, an Internet Service Provider (ISP) providing Internet service to client device 110 can contract with security platform 122 to analyze applications which client device 110 attempts to download. As another example, the owner of client device 110 can install software on client device 110 that communicates with security platform 122 (e.g., to receive content packages from security platform 122, use the received content packages to check attachments in accordance with techniques described herein, and transmit applications to security platform 122 for analysis).

### Analyzing Samples Using Static/Dynamic Analysis

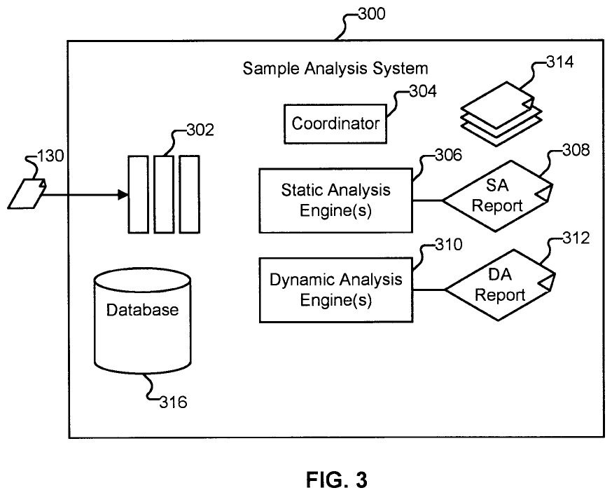

FIG. 3 illustrates an example of logical components that can be included in a system for analyzing samples. Analysis system 300 can be implemented using a single device. For example, the functionality of analysis system 300 can be implemented in a malware analysis module that includes an APT detector (e.g., APT detector 112 as shown in FIG. 1) incorporated into data appliance 102. Analysis system 300 can also be implemented, collectively, across multiple distinct devices. For example, the functionality of analysis system 300 can be provided (e.g., in whole or in part) by security platform 122.

In various embodiments, analysis system 300 makes use of lists, databases, or other collections of known safe content and/or known bad content (collectively shown in FIG. 3 as collection 314). Collection 314 can be obtained in a variety of ways, including via a subscription service (e.g., provided by a third party) and/or as a result of other processing (e.g., performed by data appliance 102 and/or security platform 122). Examples of information included in collection 314 are: URLs, domain names, and/or IP addresses of known malicious servers; URLs, domain names, and/or IP addresses of known safe servers; URLs, domain names, and/or IP addresses of known command and control (C2/C&C) domains; signatures, hashes, activities/behaviors/patterns and/or other identifiers of known malicious applications and/or APT attacks; signatures, hashes, and/or other identifiers of known safe applications; signatures, hashes, and/or other identifiers of known malicious files (e.g., OS exploit files); signatures, hashes, and/or other identifiers of known safe libraries; and signatures, hashes, and/or other identifiers of known malicious libraries.

In various embodiments, when a new sample is received for analysis (e.g., an existing signature associated with the sample is not present in analysis system 300), it is added to queue 302. As shown in FIG. 3, application 130 is received by system 300 and added to queue 302.

Coordinator 304 monitors queue 302, and as resources (e.g., a static analysis worker) become available, coordinator 304 fetches a sample from queue 302 for processing (e.g., fetches a copy of malware 130). In particular, coordinator 304 first provides the sample to static analysis engine 306 for static analysis. In some embodiments, one or more static analysis engines are included within analysis system 300, where analysis system 300 is a single device. In other embodiments, static analysis is performed by a separate static analysis server that includes a plurality of workers (i.e., a plurality of instances of static analysis engine 306).

The static analysis engine obtains general information about the sample, and includes it (along with heuristic and other information, as applicable) in a static analysis report 308. The report can be created by the static analysis engine, or by coordinator 304 (or by another appropriate component) which can be configured to receive the information from static analysis engine 306. As an example, static analysis of malware can include performing a signature-based analysis. In some embodiments, the collected information is stored in a database record for the sample (e.g., in database 316), instead of or in addition to a separate static analysis report 308 being created (i.e., portions of the database record form the report 308). In some embodiments, the static analysis engine also forms a verdict with respect to the application (e.g., “safe,” “suspicious,” or “malicious”). As one example, the verdict can be “malicious” if even one “malicious” static feature is present in the application (e.g., the application includes a hard link to a known malicious domain). As another example, points can be assigned to each of the features (e.g., based on severity if found; based on how reliable the feature is for predicting malice; etc.) and a verdict can be assigned by static analysis engine 306 (or coordinator 304, if applicable) based on the number of points associated with the static analysis results.

Once static analysis is completed, coordinator 304 locates an available dynamic analysis engine 310 to perform dynamic analysis on the application. As with static analysis engine 306, analysis system 300 can include one or more dynamic analysis engines directly. In other embodiments, dynamic analysis is performed by a separate dynamic analysis server that includes a plurality of workers (i.e., a plurality of instances of dynamic analysis engine 310).

Each dynamic analysis worker manages a virtual machine instance (e.g., emulation/sandbox analysis of samples for malware detection, such as the herein disclosed infection chain based APT attack detection based on monitored network traffic activity). In some embodiments, results of static analysis (e.g., performed by static analysis engine 306), whether in report form (308) and/or as stored in database 316, or otherwise stored, are provided as input to dynamic analysis engine 310. For example, the static report information can be used to help select/customize the virtual machine instance used by dynamic analysis engine 310 (e.g., Microsoft Windows 7 SP 2 vs. Microsoft Windows 10 Enterprise, or iOS 11.0 vs. iOS 12.0). Where multiple virtual machine instances are executed at the same time, a single dynamic analysis engine can manage all of the instances, or multiple dynamic analysis engines can be used (e.g., with each managing its own virtual machine instance), as applicable. As will be explained in more detail below, during the dynamic portion of the analysis, actions taken by the application (including network activity) are analyzed.

In various embodiments, static analysis of a sample is omitted or is performed by a separate entity, as applicable. As one example, traditional static and/or dynamic analysis may be performed on files by a first entity. Once it is determined (e.g., by the first entity) that a given file is malicious, the file can be provided to a second entity (e.g., the operator of security platform 122) specifically for additional analysis with respect to the malware's use of network activity (e.g., by a dynamic analysis engine 310).

The environment used by analysis system 300 is instrumented/hooked such that behaviors observed while the application is executing are logged as they occur (e.g., using a customized kernel that supports hooking and logcat). Network traffic associated with the emulator is also captured (e.g., using pcap). The log/network data can be stored as a temporary file on analysis system 300, and can also be stored more permanently (e.g., using HDFS or another appropriate storage technology or combinations of technology, such as MongoDB). The dynamic analysis engine (or another appropriate component) can compare the connections made by the sample to lists of domains, IP addresses, etc. (314) and determine whether the sample has communicated (or attempted to communicate) with malicious entities.

As with the static analysis engine, the dynamic analysis engine stores the results of its analysis in database 316 in the record associated with the application being tested (and/or includes the results in report 312 as applicable). In some embodiments, the dynamic analysis engine also forms a verdict with respect to the application (e.g., “safe,” “suspicious,” or “malicious”). As one example, the verdict can be “malicious” if even one “malicious” action is taken by the application (e.g., an attempt to contact a known malicious domain is made, or an attempt to exfiltrate sensitive information is observed). As another example, points can be assigned to actions taken (e.g., based on severity if found; based on how reliable the action is for predicting malice; etc.) and a verdict can be assigned by dynamic analysis engine 310 (or coordinator 304, if applicable) based on the number of points associated with the dynamic analysis results. In some embodiments, a final verdict associated with the sample is made based on a combination of report 308 and report 312 (e.g., by coordinator 304).

Embodiments for providing intrusion prevention based on infection chains will now be further described below.

### Example Attack Chain Detected Using Intrusion Prevention Based on Infection Chains Techniques

Below is an example attack chain that can be effectively and efficiently detected using the disclosed intrusion detection based on infection chain techniques (e.g., for more information on this example attack chain, see, e.g., the publicly available web page with additional links/downloadable information that is available at https://www.malware-traffic-analysis.net/2023/01/23/index.html).

The infection chain for this example APT attack is summarized below.
Google ad->fake AnyDesk page->MSI->traffic for persistent DLL->traffic for additional DLL->post-infection C2.

The Google advertisement link is provided below.
https://www.googleadservices.com/pagead/aclk?sa=L&ai=DChcSEwjXyOnToN78AhW 3fG8EHXGmBggYABABGgJqZg&ohost=www.google.com&cid=CAASJuRoQHLLOU jPJuRfBwY5hCvWnzj89qG_kmWAzxtkdnaNbPIEIHZF&sig=AOD64_3_5fOmGsshEy XOapF53KCoq3rWA&q&adurl&ved=2ahUKEwiOwuHTON78AhVGIGoFHRKEAOM QOQx6BAgLEAE-188.127.239.132—https://www.amydecke.online/?gclid=EAIaIQobChMI18jp06De_AIVt3xvBB1xpgYIEA AYASAAEgK_1PD_BwE

The spoofed/fake ANYDESK web page information is provided below.
191.101.13.129—https://anydeskcloud.tech/?gclid=EAIaIQobChMI18jp06De_AIVt3xvBB1xpgYIEAAYA SAAEgK_1PD_BwE

The MSI file download page information is provided below.
191.101.13.129-https://anydeskcloud.tech/download/AnyDeskSetup_26b30163.msi

The downloaded MSI file information is provided below.
SHA256 hash:
e4edb4cc8f35c7bab6e89774a279593d492714fce9865e53879f87d3704ad96c
File size: 11,544,064 bytes
File name: AnyDeskSetup_26b30163.msi
File description: MSI installer for TA505 malware
Sample:
https://bazaar.abuse.ch/sample/e4edb4cc8f35c7bab6e89774a279593d492714fce9865e53 879f87d3704ad96c/
Note: SHA256 hash for this sample was first reported in VirusTotal (VT) on 2022 Dec. 1.

The infection traffic information is summarized below.
152.89.196.75—https://download-cdn.com/download.php?f=Ldrp.dll&from=AnyDeskSetup_26b30163.msi<-DLL for persistent malware.
152.89.196.75—https://download-cdn.com/pload/26b30163<-Follow-up DLL retrieved by persistent malware

An example of this persistent malware is provided below.
SHA256 hash:
caaea7ec83956a823420a78dec430fddb5db65d9fa4bc6555659b9b0c05c817a
File size: 112,640 bytes
File location: https://download-cdn.com/download.php?f=Ldrp.dll&from=AnyDeskSetup_26b30163.msi
File location: C: \ProgramData\1c220cdc.dat
File description: DLL used to keep TA505 malware persistent
Sample:
https://bazaar.abuse.ch/sample/caaea7ec83956a823420a78dec430fddb5db65d9fa4bc6555 659b9b0c05c817a/.
Run method: rundll32.exe [filename], #2
Note: File hash and file name are different each time the MSI file installer is run, although file size and placement under C: \ProgramData\ directory remain consistent.

The post-infection C2 traffic example is provided below.
64.190.113.123:443-TCP traffic

Example of the malware responsible for the post-infection traffic is provided below.
SHA256 hash:
e14ee6302076a2bb9e5634407500757319d5de9c45305ec6269120b7283b24cf
File size: 94,720 bytes
File location: https://download-cdn.com/pload/26b30163
File description: DLL retrieved by persistent malware but not saved to disk
Sample:
https://bazaar.abuse.ch/sample/e14ee6302076a2bb9e5634407500757319d5de9c45305ec6 269120b7283b24cf/.
Note: File hash is different each time this file is retrieved from download-cdn.com

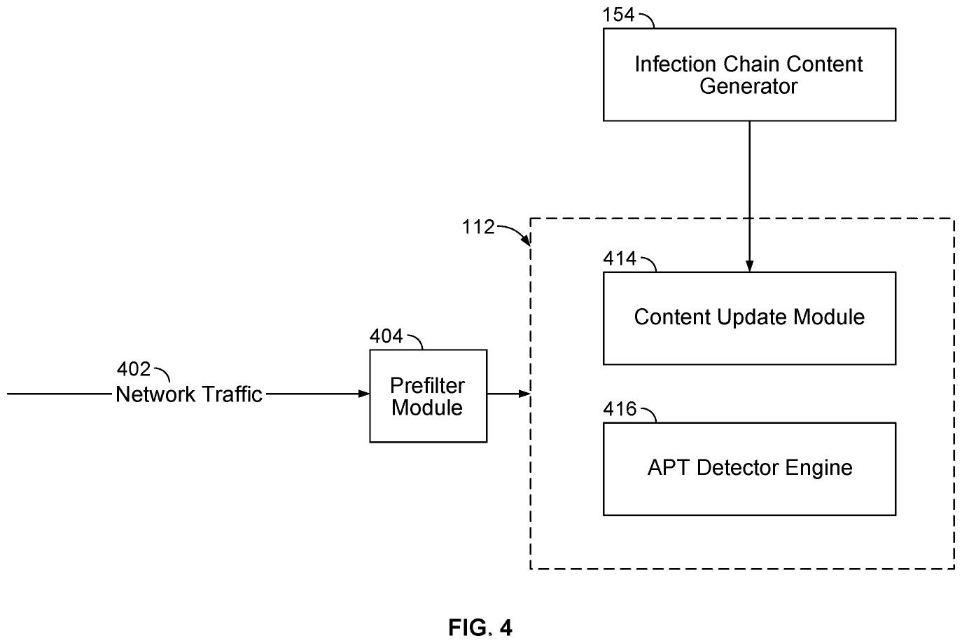

The above-described example infection chain is used below for illustrating example prefiltering logic and infection chain signature generation for performing the disclosed techniques for APT detection using infection chains as will now be further described with respect to FIG. 4.

### APT Detector Using Infection Chain Based Signatures

FIG. 4 is a component diagram of the advanced persistent threat (APT) detector in accordance with some embodiments. As shown in FIG. 4, APT detector 112 receives network traffic 402 that can be filtered (optionally) using a prefilter module 404 (e.g., which can be implemented as part of the APT detector or a component of the security platform, such as the security platform 102 of FIG. 1), such as further described below. The (pre-filtered) network traffic can be analyzed for potential APT attack related activities using an APT detector engine of the APT detector that applies various infection chain based signatures as will also be further described below. The APT detector periodically receives updated/new infection chain based signatures from infection chain content generator 154 via content update module 414 as also shown in FIG. 4.

In this example implementation, the infection chain based threat detection system can detect and thereby block/prevent a potential APT attack based on monitoring the network traffic and detecting a match with the infection chain content (e.g., infection chain threat intelligence that can include various infection chain based signatures, which can be implemented as heuristic, behavioral-based signatures that can span distinct sessions/flows of network traffic as further described below). As shown in FIG. 4, this example implementation of the system includes the infection chain content update sub-system in communication with the infection chain content generation sub-system and the infection chain content engine that determines whether the monitored network traffic triggers/matches any of the infection chain based signatures. Specifically, the infection chain content generation system can translate and transform the infection chain threat intelligence into the infection chain behavior signatures. The APT detector engine 416 loads the infection chain behavior signature content and reports a detected APT attack for an enforcement policy decision if there is a hit/match with one or more of the infection chain behavior signatures. The content update module can periodically update the infection chain behavior signature content (e.g., in near real-time) from the infection chain content generator.

### Prefiltering Module

In this example implementation, the prefiltering module can optionally be included to improve/optimize performance for the disclosed intrusion prevention based on infection chains. Specifically, various filtering operations can be performed on the network traffic/session using the prefiltering module to determine whether to perform further security analysis for intrusion prevention based on infection chains, which includes further APT related behavior analysis based on infection chains, such as further described below.

An example of such filtering operations that can be performed using the prefiltering module is provided below. This example set of filters can be applied to facilitate APT detection of certain attackers, such as the well-known TA505 cybercriminal group that has been associated with various ransomware-as-a service (RaaS) activities, initial access broker (IAB) activities (e.g., selling access to compromised enterprise/corporate networks), as well as large botnet operator activities for financial fraud and/or phishing/data exfiltration activities.

An example set of prefiltering operations for the following example infection chain: “Google ad->fake AnyDesk page->MSI->traffic for persistent DLL->traffic for additional DLL->post-infection C2”, is provided below.

```
<filters>
  <filter>
    <id>1</id>
    <pattern>googleadservices</pattern>
    <field>dns</field>
  </filter>
  <filter>
    <id>2</id>
    <pattern>googleadservices</pattern>
    <field>ssl-sni</field>
  </filter>
  <condition> (1 or 2) </condition>
</filters>
```

Various other filtering operations can similarly be applied for different potential types of APT attacks as will now be apparent to one of ordinary skill in the art in view of the disclosed embodiments.

### Infection Chain Content Generator

In this example implementation, the infection chain content generator is configured to automatically parse the infection chain threat intelligence information. The distinct set of attack activities/behaviors are extracted and then stitched together as the core APT attack factors. From the extracted distinct set of attack activities/behaviors, the infection chain content generator can automatically generate a new multi-session infection chain based APT detection signature (e.g., which can include prefiltering operations, such as similarly described above using the prefilter module, and behavioral APT detection logic for matching the extracted distinct set of attack activities/behaviors).

For example, these automatically generated multi-session infection chain based APT detection signatures can be described by self-defined extensible markup language (XML) syntax and keyword with logic “&”, “|”, “!” as will be further described below with respect to example infection chain based signatures for APT detection.

An example signature for the above-referenced infection chain of the following: “Google ad->fake AnyDesk page->MSI->traffic for persistent DLL->traffic for additional DLL->post-infection C2”, is provided below.

```
<behaviors>
  <behavior>
    <id>3</id>
    <pattern> [a-z] {4, 32}, [a-z] {4} </pattern>
    <field>dns</field>
  </behavior>
  <behavior>
    <id>4</id>
    <pattern> [a-z] {4, 32}. [a-z] {4} </pattern>
    <field>ssl-sni</field>
  </behavior>
  // APT attack pattern reveals the use of a CDN for malware downloading //
  <behavior>
    <id>5</id>
    <pattern> .*.cdn.com </pattern>
    <field>dns</field>
  </behavior>
  <behavior>
    <id>6</id>
    <pattern> .*.cdn.com </pattern>
    <field>ssl-sni</field>
  </behavior>
  // APT attack pattern reveals that port 443 is being used for non-SSL traffic //
  <behavior>
    <id>7</id>
    <port> 443 </dport>
    <pattern> \x16 03 01\x </pattern>
    <field>unknown-tcp-payload</field>
    <negate>yes</negate>
  </behavior>
  // APT attack pattern must match this condition logic for an APT signature detection //
  <condition> (3 or 4) and (5 or 6) and 7 </condition>
</behaviors>
</signature>
```

### APT Detector Engine

In this example implementation, the APT detector engine is configured to automatically parse each of the multi-session infection chain based APT detection signatures (e.g., XML implemented signature rules, such as further described herein). Specifically, the APT detector engine generates a prefilter IP node and a state machine (e.g., an AC state machine) for performing the pattern matching operations for APT detection based on the infection chain based signatures.

More specifically, the IP node can be created based on the prefiltering check, a time out can be set for each IP static node, and an APT/malicious verdict is returned if a match is detected if there is a logic match for at least one of the infection chain based signatures. If there is a match and the APT/malicious verdict is returned, then the security platform can be configured to perform a responsive action based on a policy (e.g., a security/APT rule(s) in the policy that allow, block, log, quarantine, and/or perform another responsive action, such as to block the final C2 traffic once the infection chain based signature is triggered).

### Content Update Module

In this example implementation, the content update module is configured to automatically manage and update the multi-session infection chain based APT detection signature content from updating the server (e.g., the infection chain content generator).

As such, the disclosed APT detector applying the multi-session infection chain based APT detection signature content can detect new/variant APT attacks (e.g., zero-day APT attacks) as such multi-session, behavioral pattern signatures are effective and efficient for detecting new/variant APT attacks as attackers typically do not change their behavioral patterns (e.g., while the APT attackers may change domains, web pages/advertisements associated with their crafted APT attack patterns, the APT attackers typically maintain a common base pattern of such behaviors, such as an online advertisement that is associated with a fake/compromised web page for downloading an executable, such as an MSI that installs C2 malware for performing nefarious activities, such as data exfiltration, etc.).

Accordingly, the disclosed techniques for intrusion prevention based on infection chains facilitate the following: (1) self-defined XML based multi-session detection logic description syntax; and (2) a (near) real-time APT detection engine based on multi-session behavior logic matching/statistics.

### Example Multi-Session Infection Chain Based APT Detection Signatures

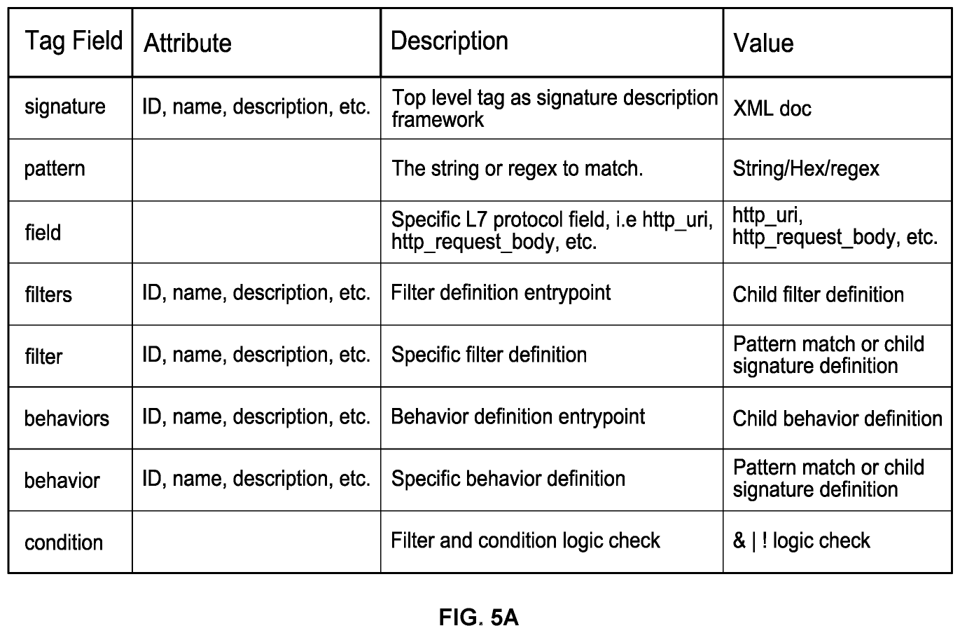

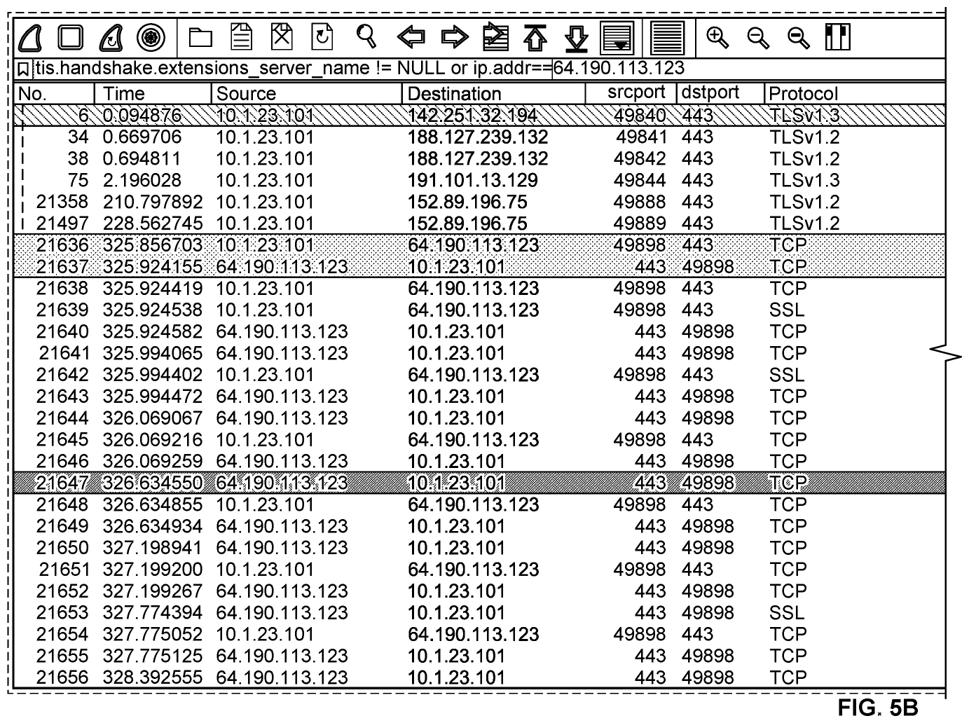

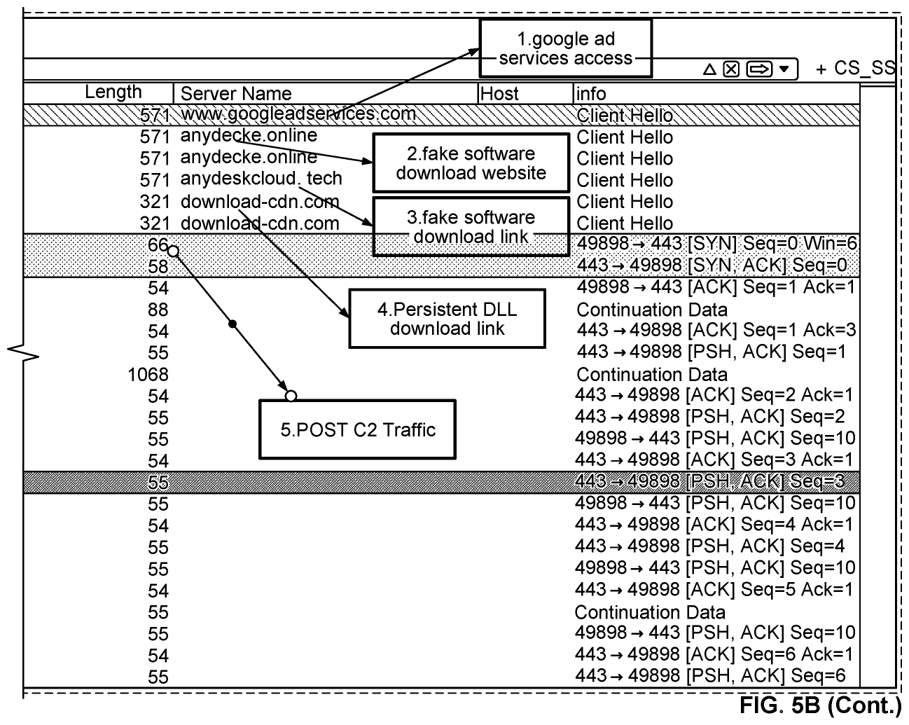

FIG. 5A illustrates elements of multi-session infection chain based APT detection signatures in accordance with some embodiments. In this example implementation, FIG. 5A illustrates the tag fields, attributes, descriptions, and values associated with elements of the multi-session infection chain based APT detection signatures. As shown, these multi-session infection chain based APT detection signatures can include various filters (e.g., for prefiltering logic), behaviors, conditions, and patterns for logic checking/matching for effective and efficient APT detection for a security (e.g., intrusion prevention) solution (e.g., which can detect new/variant/zero-day APT attacks that would typically evade existing single session, IPS signature detection approaches as similarly discussed above).

FIG. 5B is an annotated portion of a packet capture (pcap) log that illustrates an example APT attack activity pattern that can be used for generating multi-session infection chain based APT detection signatures in accordance with some embodiments. As shown in FIG. 5B, at a first stage, a Google ad services access network activity is performed. At a second stage, an executable (e.g., compromised/fake software/program) is downloaded from a web site (e.g., a malicious/compromised web site, in this example, it is a malicious site using a “online” domain to attempt to trick the user into believing it is a legitimate web site). At a third stage, the software is downloaded via a link from a Content Distribution Network (CDN) (e.g., malware/APT attackers often use such CDN sites for malware distribution). At a fourth stage, a persistent Dynamically Linked Library (DLL) download link is provided as shown. At a fifth stage, the malware executing on the targeted user's device is sending out information (e.g., data exfiltration) via POST C2 traffic.

Additional example processes for the disclosed techniques for intrusion prevention based on infection chains will now be described.

### Example Processes for Intrusion Prevention Based on Infection Chains

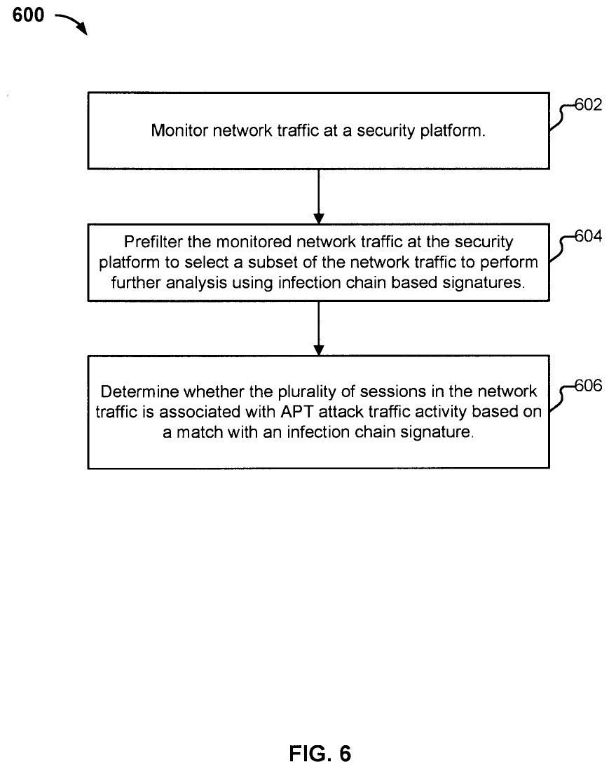

FIG. 6 is a flow diagram of a process for intrusion prevention based on infection chains in accordance with some embodiments. In some embodiments, a process 600 as shown in FIG. 6 is performed by the security platform and techniques as similarly described above including the embodiments described above with respect to FIGS. 1-5B. In one embodiment, process 600 is performed by data appliance 102 (e.g., a security platform) as described above with respect to FIG. 1, security platform 122 as described above with respect to FIG. 1 (e.g., as a cloud-based security service), a virtual appliance (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 602, network traffic is monitored at a security platform (e.g., a firewall). For example, the firewall can monitor a plurality of distinct sessions/flows in the network traffic, such as similarly described above with respect to FIGS. 1-5B.

At 604, prefiltering the monitored network traffic is performed at the security platform to select a subset of the network traffic to perform further analysis using infection chain based signatures. For example, a prefiltering module can perform heuristic analysis of the network traffic to select a subset of traffic sessions to forward to the APT detector for further analysis using infection chain based signatures, such as similarly described above with respect to FIGS. 4 and 5A-5B.

At 606, determining whether the plurality of sessions in the network traffic is associated with APT attack traffic activity based on a match (e.g., logic match) with an infection chain signature is performed. For example, the infection chain signature can be automatically generated to facilitate detection of APT attack related behavior for automatically detecting APT attack traffic, such as similarly described above with respect to FIGS. 4 and 5A-5B.

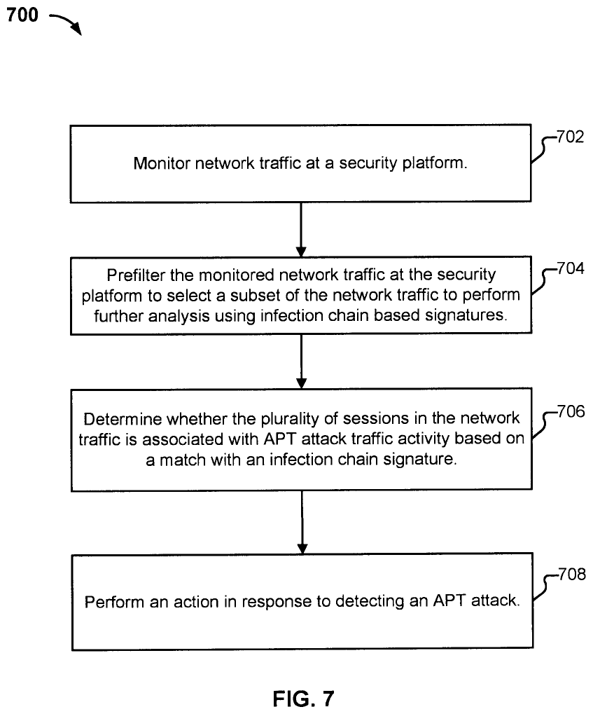

FIG. 7 is a flow diagram of a process for intrusion prevention based on infection chains in accordance with some embodiments. In some embodiments, a process 700 as shown in FIG. 7 is performed by the security platform and techniques as similarly described above including the embodiments described above with respect to FIGS. 1-5B. In one embodiment, process 700 is performed by data appliance 102 as described above with respect to FIG. 1, security platform 122 as described above with respect to FIG. 1 (e.g., as a cloud-based security service), a virtual appliance (e.g., Palo Alto Networks' VM Series virtualized next generation firewalls, CN Series container next generation firewalls, and/or other commercially available virtual-based or container-based firewalls can similarly be implemented and configured to perform the disclosed techniques), an SDN security solution, a cloud security service, and/or combinations or hybrid implementations of the aforementioned as described herein.

At 702, network traffic is monitored at a security platform (e.g., a firewall). For example, the firewall can monitor a plurality of distinct sessions/flows in the network traffic, such as similarly described above with respect to FIGS. 1-5B.

At 704, prefiltering the monitored network traffic is performed at the security platform to select a subset of the network traffic to perform further analysis using infection chain based signatures. For example, a prefiltering module can perform heuristic analysis of the network traffic to select a subset of traffic sessions to forward to the APT detector for further analysis using infection chain based signatures, such as similarly described above with respect to FIGS. 4 and 5A-5B.

At 706, determining whether the plurality of sessions in the network traffic is associated with APT attack traffic activity based on a match (e.g., logic match) with an infection chain signature is performed. For example, the infection chain signature can be automatically generated to facilitate detection of APT attack related behavior for automatically detecting APT attack traffic, such as similarly described above with respect to FIGS. 4 and 5A-5B.

At 708, an action is performed in response to detecting APT attack traffic activity based on a match with the infection chain signature. The security platform (122) and/or data appliance/security platform (102) can then perform an action based on a policy (e.g., security/APT related malware policy, which can be stored in policies 252 as shown in FIG. 2B) in response to the malware verdict. For example, the data appliance can be configured to block the APT attack traffic activity (e.g., block the C2 traffic activity associated with the APT attack, such as similarly described above). Other example actions can include blocking access to the destination IP address associated with the detected APT attack traffic activity, blocking/dropping the network traffic associated with the detected APT attack traffic activity and/or associated with that destination IP address, alerting an endpoint user and/or a network/security administrator that the endpoint was associated with the detected APT attack traffic activity, quarantining an endpoint device associated with the detected APT attack traffic activity, identifying the destination IP address, URL, etc. associated with the detected APT attack traffic activity as malicious (or potentially malicious), and/or various other actions can also be performed based on the policy.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
monitor network traffic at a security platform;
prefilter the monitored network traffic at the security platform to select a subset of the network traffic to perform further analysis using a plurality of signatures based on infection chains; and
determine whether a plurality of sessions in the network traffic is associated with advanced persistent threat (APT) attack traffic activity based on a match with at least one of the plurality of signatures based on the infection chains; and
a memory coupled to the processor and configured to provide the processor with instructions.

2. The system of claim 1, wherein the security platform includes a firewall.

3. The system of claim 1, wherein prefiltering improves performance for signature detection matching.

4. The system of claim 1, wherein the at least one of the plurality of signatures based on the infection chains is an intrusion prevention system (IPS) signature.

5. The system of claim 1, wherein the at least one of the plurality of signatures based on the infection chains includes extensible markup language (XML) syntax.

6. The system of claim 1, wherein the at least one of the plurality of signatures based on the infection chains includes extensible markup language (XML) syntax with one or more logic connectors.

7. The system of claim 1, wherein the processor is further configured to perform an action in response to detecting the APT attack traffic activity.

8. The system of claim 1, wherein the processor is further configured to receive periodic updates of the plurality of signatures based on the infection chains.

9. A method, comprising:
monitoring network traffic at a security platform;
prefiltering the monitored network traffic at the security platform to select a subset of the network traffic to perform further analysis using a plurality of signatures based on infection chains; and
determining whether a plurality of sessions in the network traffic is associated with advanced persistent threat (APT) attack traffic activity based on a match with at least one of the plurality of signatures based on the infection chains.

10. The method of claim 9, wherein the security platform includes a firewall.

11. The method of claim 9, wherein prefiltering improves performance for signature detection matching.

12. The method of claim 9, wherein the at least one of the plurality of signatures based on the infection chains is an intrusion prevention system (IPS) signature.

13. The method of claim 9, wherein the at least one of the plurality of signatures based on the infection chains includes extensible markup language (XML) syntax.

14. The method of claim 9, wherein the at least one of the plurality of signatures based on the infection chains includes extensible markup language (XML) syntax with one or more logic connectors.

15. The method of claim 9, wherein the processor is further configured to perform an action in response to detecting the APT attack traffic activity.

16. The method of claim 9, wherein the processor is further configured to receive periodic updates of the plurality of signatures based on the infection chains.

17. A computer program product embodied in a non-transitory computer readable medium and comprising computer instructions for:
monitoring network traffic at a security platform;
prefiltering the monitored network traffic at the security platform to select a subset of the network traffic to perform further analysis using a plurality of signatures based on infection chains; and
determining whether a plurality of sessions in the network traffic is associated with advanced persistent threat (APT) attack traffic activity based on a match with at least one of the plurality of signatures based on the infection chains.

18. The computer program product of claim 17, wherein the security platform includes a firewall.

19. The computer program product of claim 17, wherein prefiltering improves performance for signature detection matching.

20. The computer program product of claim 17, wherein the at least one of the plurality of signatures based on the infection chains is an intrusion prevention system (IPS) signature.

21. A system, comprising:
a processor configured to:
parse threat intelligence information to extract a set of behaviors associated with an advanced persistent threat (APT) attack;
extract the set of behaviors associated with the APT attack; and
automatically generate a multi-session-based detection signature with prefilter and logic based on an infection chain; and
a memory coupled to the processor and configured to provide the processor with instructions.
